(19) United States
(12) Patent Application Publication
(10) Pub. No.: US 2026/0351846 A1
(43) Pub. Date: Nov. 5, 2026

(54) MULTIPLE-INPUT MULTIPLE-OUTPUT ANTENNA

(71) Applicant: LG INNOTEK CO., LTD., Seoul (KR)

(72) Inventors: Jong Min KIM, Seoul (KR); Yu Seon KIM, Seoul (KR); Seok BAE, Seoul (KR)

(73) Assignee: LG INNOTEK CO., LTD., Seoul (KR)

(21) Appl. No.: 19/118,596

(22) PCT Filed: Aug. 1, 2023
(86) PCT No.: PCT/KR2023/011194

§ 371 Date: Apr. 4, 2025

(30) Foreign Application Priority Data
Oct. 5, 2022 (KR) 10-2022-0126995

(51) Int. Cl. H01Q 1/52; H01Q 21/28; H04B 7/0413

(52) U.S. Cl. CPC H01Q 1/521; H01Q 21/28; H04B 7/0413

(57) ABSTRACT

The present invention relates to a multiple-input multiple-output antenna having a decoupling structure in a non-ground area, the antenna comprising: a substrate including a ground area and a non-ground area; a first antenna and a second antenna formed to be spaced apart from each other in the non-ground area; and a pattern part disposed in the non-ground area between the first antenna and the second antenna and having a plurality of induction patterns that cancel out the coupling of the first antenna and the second antenna. The pattern part comprises: a square spiral-shaped first pattern disposed at a predetermined distance from the first antenna; a ground pattern connecting an end of the first pattern and the ground area; a square spiral-shaped second pattern disposed in a position symmetrical to the first pattern with respect to the ground pattern; and a square spiral-shaped third pattern disposed between the ground pattern and the ground area, wherein, when two or more antennas using the same frequency band exist, mutual electromagnetic interference between the two antennas can be blocked, and isolation can be improved by preventing current from flowing into other antennas through coupling.

### TECHNICAL FIELD

The present disclosure relates to a multiple-input multiple-output antenna, and more particularly to a multiple-input multiple-output antenna having a decoupling structure in a non-ground area.

### BACKGROUND ART

As the demand for multimedia services increases, mobile communication systems are required to transmit high speed data with reliability. In order to transmit data at high speeds through wireless channels that use limited bandwidth and power, an increased capacity is essential. Recently, interest in technologies that improve a capacity has been increasing

In wireless communication environments, the reliability of received signals is greatly reduced due to fading, shadowing, radio attenuation, noise, interference, etc. Therefore, in order to enable high-speed data communication, an alternative to overcome or utilize these wireless channel characteristics is needed, and in order to meet this need, Multi Input Multi Output (MIMO) antenna technology is proposed.

The MIMO antenna technology is technology that transmits data using multiple antennas in a transmitter or a receiver, and uses a spatial multiplexing technique.

The MIMO antenna technology has an advantage of expanding the range of wireless communication and greatly increasing the speed thereof by transmitting two or more data signals on the same wireless channel using multiple antennas.

However, in the MIMO antenna technology, because two or more antenna elements are disposed, interference between radiators may occur. Such interference may distort a radiation pattern or cause mutual coupling between the radiators, and therefore, technology to secure isolation between antennas is required.

### DISCLOSURE

### Technical Problem

It is an object of the present disclosure to provide a multiple-input multiple-output antenna capable of minimizing coupling between antennas without changing the shape of existing antennas.

The technical problems of the present disclosure are not limited to the technical problems mentioned above, and other technical problems not mentioned will be clearly understood by those skilled in the art from the following description.

### Technical Solution

In accordance with the present disclosure, the above and other objects can be accomplished by the provision of a multiple-input multiple-output antenna including a substrate comprising a ground area and a non-ground area, a first antenna and a second antenna formed to be spaced apart from each other in the non-ground area, and a pattern part disposed in the non-ground area between the first antenna and the second antenna and having a plurality of induction patterns configured to cancel out coupling between the first antenna and the second antenna, wherein the pattern part includes a first pattern disposed to be spaced apart from the first antenna by a predetermined distance, a ground pattern configured to connect an end of the first pattern to the ground area, a second pattern disposed at a position symmetrical to the first pattern with respect to the ground pattern, and a third pattern disposed between the ground pattern and the ground area.

In one embodiment of the multiple-input multiple-output antenna according to the present disclosure, the number of turns of the third pattern may be greater than the number of turns of the first pattern and the number of turns of the second pattern.

In one embodiment of the multiple-input multiple-output antenna according to the present disclosure, the substrate may include an upper substrate and a lower substrate configured to be stacked, and each end of the first to third patterns may be connected to the upper substrate and the lower substrate through a via hole, respectively.

In one embodiment of the multiple-input multiple-output antenna according to the present disclosure, the first pattern and the second pattern may be disposed to have different distances from the ground area.

In one embodiment of the multiple-input multiple-output antenna according to the present disclosure, the first pattern and the second pattern may have symmetrical shapes with respect to each other.

In one embodiment of the multiple-input multiple-output antenna according to the present disclosure, the first pattern and the second pattern may transmit signals of the same frequency band.

In one embodiment of the multiple-input multiple-output antenna according to the present disclosure, the first pattern and the second pattern may have the same shape.

### Advantageous Effects

A multiple-input multiple-output antenna according to the present disclosure may block, if there are two or more antennas using the same frequency band, electromagnetic interference between two antennas, and prevent current from flowing into another antenna due to coupling, thereby being capable of improving isolation.

### DESCRIPTION OF DRAWINGS

FIG. 1 is a view illustrating a general multiple-input multiple-output antenna.

FIG. 2 is a view illustrating a multiple-input multiple-output antenna according to one embodiment of the present disclosure.

FIG. 3 shows graphs representing voltage standing wave ratios (VSWRs) and insertion loss before application of the present disclosure.

FIG. 4 shows graphs representing voltage standing wave ratios (VSWRs) and insertion loss when the present disclosure is applied.

FIGS. 5A and 5B are exemplary views showing insulation improvement before and after application of the present disclosure.

### BEST MODE

With respect to the embodiments of the present disclosure set forth herein, specific structural or functional descriptions are merely exemplarily given to describe the embodiments of the present disclosure, and the embodiments of the present disclosure may be implemented in various forms and should not be construed as being limited to the embodiments set forth herein.

The present disclosure may be variously modified and have various forms, and specific embodiments will be illustrated in the drawings and described in detail herein. However, this is not intended to limit the present disclosure to a specific disclosed form, and it should be understood that it includes all modifications, equivalents, or substitutes that fall within the spirit and technical scope of the present disclosure.

Terms, such as “first,”, “second,” and the like, are used to describe various elements, and these elements should not be construed as being limited by these terms. These terms are used only to distinguish one element from other elements. For example, a first element described hereinafter may be termed a second element, and similarly, a second element described hereinafter may be termed as a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other expressions used to describe relationships between elements should be interpreted in a like fashion, e.g., “between” versus “directly between,” “adjacent” versus “directly adjacent,” etc.

The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, steps, operations, elements, components, and/or combinations thereof, but do not preclude the possibility of the presence or addition of one or more other features, integers, steps, operations, elements, components, and/or combinations thereof.

Unless otherwise defined, all terms used herein, including technical or scientific terms, have the same meaning as generally understood by those skilled in the art to which the present disclosure pertains. Terms defined generally used in dictionaries should be interpreted as having meanings consistent with the meanings thereof in the context of the relevant technology, and should not be interpreted as having ideal or excessively formal meanings unless explicitly defined in the description.

In addition, in cases where an embodiment is capable of being implemented differently, functions or operations specified in a specific block may occur in a different order from the order specified in a flowchart. For example, two consecutive blocks may actually be performed substantially simultaneously, or the blocks may be performed in reverse depending on the related function or operation.

Hereinafter, a multiple-input multiple-output antenna according to the present disclosure will be described with reference to the accompanying drawings.

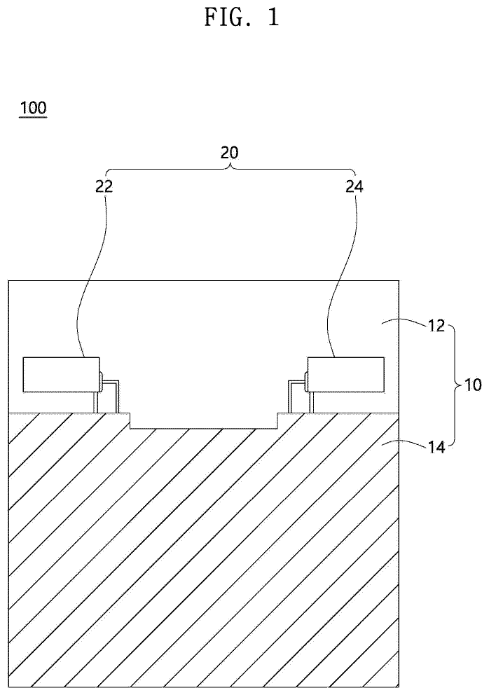

FIG. 1 is a view illustrating a general multiple-input multiple-output antenna. Because multiple antennas are used in a Multi Input Multi Output (MIMO) antenna, interference between the antennas may occur. Accordingly, a radiation pattern may be distorted or mutual coupling between the respective antennas may occur. Furthermore, in order to implement a multiple-input multiple-output antenna in a limited space, two or more antenna elements must be disposed in a small space, thereby causing difficulty in improving isolation characteristics.

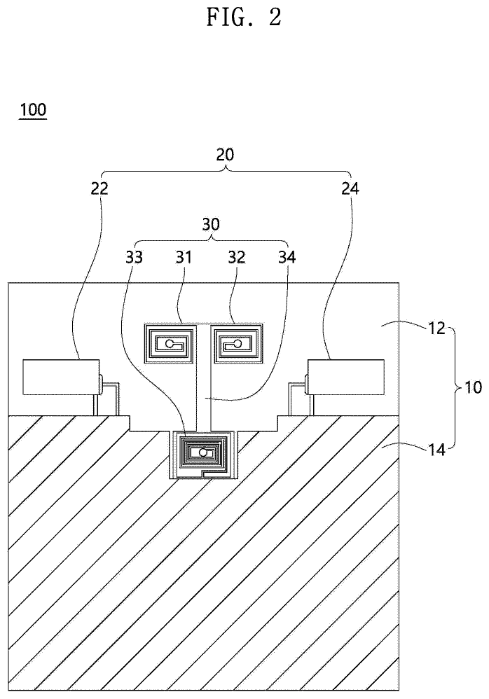

FIG. 2 is a view illustrating a multiple-input multiple-output antenna according to one embodiment of the present disclosure. Referring to FIG. 2, a multiple-input multiple-output antenna 100 according to one embodiment of the present disclosure includes a substrate 10, a plurality of antennas 20, and a pattern part 30.

The substrate 10 may be implemented as a single dielectric or multiple dielectrics having metal surfaces on the upper and lower surfaces thereof. One surface of the substrate 10 may include a non-ground area 12 and a ground area 14. The ground area 14 is formed with a certain area on the substrate 10.

The plurality of antennas 20 may include two or more antennas. In one embodiment, the plurality of antennas 20 may include a first antenna 22 and a second antenna 24. The first antenna 22 and the second antenna 24 may refer to two antennas that are closest to each other.

In one embodiment, the first antenna 22 may be formed on one side of the non-ground area 12, and the second antenna 24 may be formed on the other side of the non-ground area 12. In addition, the first antenna 22 and the second antenna 24 may have the same structure to transmit signals of the same frequency band, and be disposed to be spaced apart from each other by a predetermined distance. The distance between the first antenna 22 and the second antenna 24 may be adjusted as needed. The first antenna 22 and the second antenna 24 may be modified depending on a required frequency band.

The pattern part 30 is disposed in the non-ground area 12 between the first antenna 22 and the second antenna 24 and includes a plurality of induction patterns that cancels out coupling between the first antenna 22 and the second antenna 24.

The pattern part 30 includes a square spiral-shaped first pattern disposed to be spaced apart from the first antenna 22 by a predetermined distance, a ground pattern 34 that connects the end of the first pattern 31 to the ground area, a square spiral-shaped second pattern 32 disposed at a position symmetrical to the first pattern 31 with respect to the ground pattern 34, and a square spiral-shaped third pattern 33 disposed between the ground pattern 34 and the ground area 14.

If the first pattern 31, the second pattern 32, and the third pattern 33 are formed in a spiral shape, they are used in the form of a resonator to reduce coupling in a structure where adjacent antennas share a ground. Because all of the first to third patterns 31-33 are related to frequency, each length thereof depends on the frequency.

The first antenna 22 and the second antenna 24 have the same shape, and transmit signals of the same frequency band. This is one embodiment and the present disclosure is not limited thereto.

The first pattern 31 and the second pattern 32 have symmetrical shapes with respect to each other and are disposed to have different distances from the ground area 14. This is also one embodiment and the present disclosure is not limited thereto.

Basically, the first pattern 31 and the second pattern 32 are main elements that perform decoupling, and the third pattern 34 may be used to remove a small amount of coupling in the structure where the adjacent antennas share the ground. That is, coupling may be first canceled out by the first and second patterns 31 and 32, and the remaining coupling component may be secondarily canceled out by the third pattern 33.

The number of turns of the third pattern 33 may be greater than the number of turns of the first pattern 31 and the number of turns of the second pattern 32. Because the number of turns depends on the resonant frequency, it is better if the numbers of turns of the patterns are the same, but because Bluetooth/WiFi has a frequency band of 2.424-2.484 GHz and decoupling band regions may be different in some cases, the number of turns of the first pattern 31 may be the same as the number of turns of the second pattern 32, and be the same as or smaller than the number of turns of the third pattern 33. In the same manner, the number of turns of the second pattern 32 may be the same as the number of turns of the first pattern 32, and be the same as or smaller than the number of turns of the third pattern 33.

In addition, if the substrate and a conductive layer is formed in multiple layers, the pattern part 30 may be disposed on each layer. Here, the respective ends of the pattern parts 30 may be connected by means of through vias. If the distance between the first antenna 22 and the second antenna 24 is narrow, the distance may not be suitable to define a sufficient area to form the number of turns depending on the frequency. Therefore, the vias may be formed through the stacked substrates so that the pattern part 30 may be formed on at least one substrate and connected through the vias.

The substrate includes an upper substrate and a lower substrate that are stacked, and each end of the first pattern to the third pattern is connected to the upper substrate and the lower substrate through the via hole.

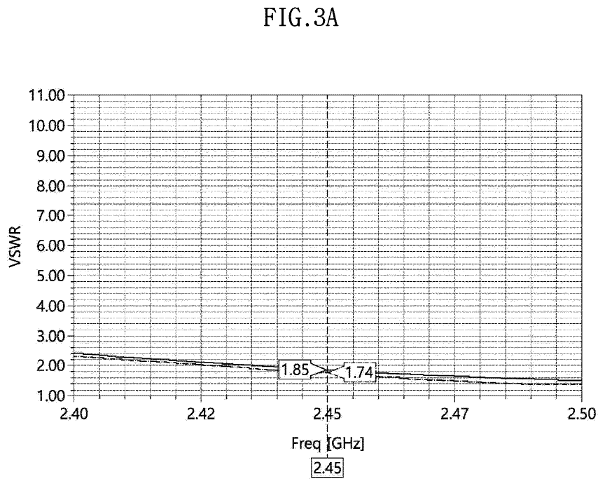

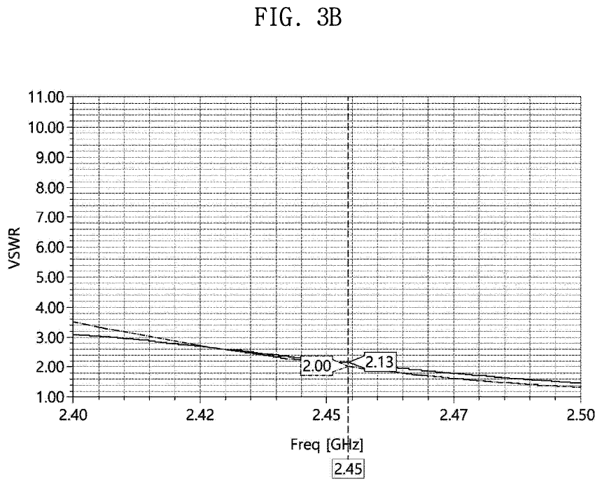

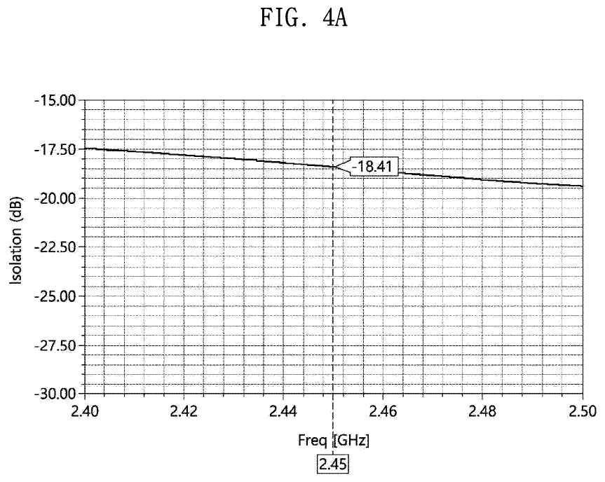

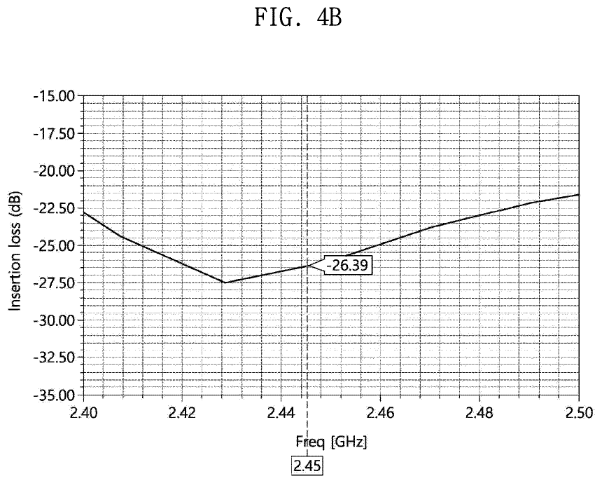

FIGS. 3A and 3B are graphs representing voltage standing wave ratios (VSWRs) and insertion loss before application of the present disclosure, and FIG. 4 shows graphs representing voltage standing wave ratios (VSWRs) and insertion loss when the present disclosure is applied.

The voltage standing wave ratio (VSWR) is the ratio of the maximum amplitude to the minimum amplitude of voltage. The insertion loss refers to signal power loss that occurs when a device is inserted into a transmission line or an optical fiber in communication, and is generally expressed in decibels (dB). That is, it is called “insertion loss” because it is loss calculated by measuring the strength of a signal when the signal arrives at a destination after being input at a starting point. Here, the insertion loss is calculated using the formula IL=−10 Log (Pout/Pin).

As shown in FIG. 3A, when the VSWR of the first antenna is 1.85 and the VSWR of the second antenna is 1.74 in a frequency band of 2.45 GHz and thus satisfy a VSWR criterion of 3.0 or less, the insertion loss that occurs in the antenna before application of the present disclosure is −18.41 dB in the frequency band of 2.45 GHz, as shown in FIG. 4A.

Meanwhile, as shown in FIG. 3B, when the VSWR of the first antenna is 2.13 and the VSWR of the second antenna is 2.00 in the frequency band of 2.45 GHz and thus satisfy the VSWR criterion of 3.0 or less, the insertion loss that occurs in the multiple-input multiple-output antenna according to the present disclosure is −26.39 dB in the frequency band of 2.45 GHz, as shown in FIG. 4B.

That is, it may be confirmed that current flowing from the first antenna to the second antenna is significantly reduced.

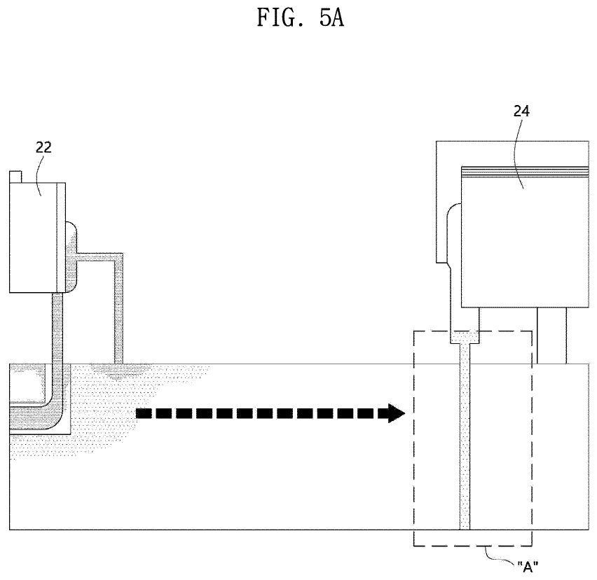

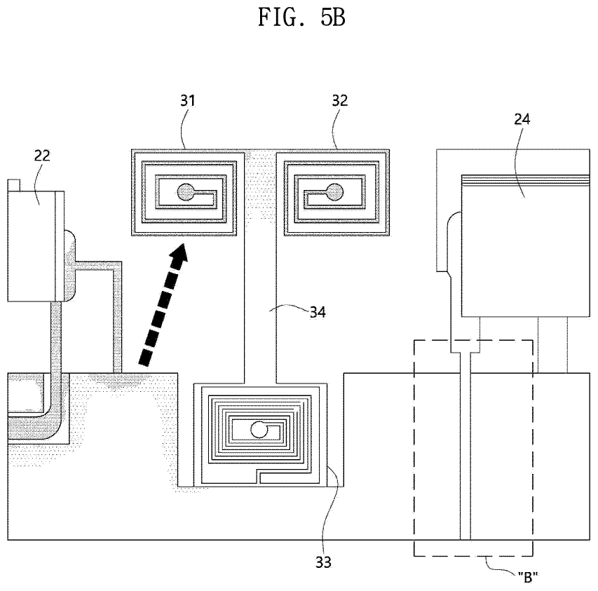

FIGS. 5A and 5B are exemplary views showing insulation improvement: before and after application of the present disclosure.

FIG. 5A is an exemplary view showing current flow in the antenna before application of the present disclosure. If a pattern part for decoupling is not applied, it may be confirmed that current (as indicated by a thick dotted line) generated from the first antenna 22 moves toward the second antenna 24 through the ground area, as indicated in area “A”.

FIG. 5B is an exemplary view showing insulation improvement of the multiple-input multiple-output antenna according to the present disclosure, and unlike the example of FIG. 5A, it may be confirmed that current (as indicated by a thick dotted line) generated from the first antenna 22 is guided to the first pattern 31 of the pattern part and does not affect the second antenna 24, as indicated in area “B”.

As is apparent from the above description, induction patterns to cancel out coupling between two adjacent antennas are disposed in a non-ground area between adjacent plural antennas as in the present disclosure, thereby being capable of reducing current introduced by the coupling.

Although the present disclosure has been described with reference to the exemplary embodiments thereof, it will be understood by those skilled in the art that the present disclosure may be variously modified and changed within the scope and spirit of the present disclosure described in the following appended claims.

### INDUSTRIAL APPLICABILITY

A multiple-input multiple-output antenna according to the present disclosure may be used in various communication devices.

1-10. (canceled)

11. A multiple-input multiple-output antenna comprising:
a substrate comprising a ground area and a non-ground area;
a first antenna and a second antenna formed to be spaced apart from each other in the non-ground area; and
a pattern part disposed in the non-ground area between the first antenna and the second antenna and having a plurality of induction patterns configured to cancel out coupling between the first antenna and the second antenna,
wherein the pattern part comprises:
a first pattern disposed to be spaced apart from the first antenna by a predetermined distance;
a ground pattern configured to connect an end of the first pattern to the ground area;
a second pattern disposed at a position symmetrical to the first pattern with respect to the ground pattern; and
a third pattern disposed between the ground pattern and the ground area.

12. The multiple-input multiple-output antenna according to claim 11, wherein the first to third patterns are formed in a square spiral shape.

13. The multiple-input multiple-output antenna according to claim 11, wherein a number of turns of the first pattern is the same as a number of turns of the second pattern, and is the same as or smaller than a number of the third pattern.

14. The multiple-input multiple-output antenna according to claim 11, wherein a number of turns of the second pattern is the same as a number of turns of the first pattern, and is the same as or smaller than a number of the third pattern.

15. The multiple-input multiple-output antenna according to claim 11, wherein the substrate is formed in multiple layers, and the pattern part is formed on at least one substrate.

16. The multiple-input multiple-output antenna according to claim 15, wherein the substrate includes an upper substrate and a lower substrate stacked to each other, and each end of the first to third patterns is connected to the upper substrate and the lower substrate through a via hole, respectively.

17. The multiple-input multiple-output antenna according to claim 11, wherein the first pattern and the second pattern are disposed to have different distances from the ground area.

18. The multiple-input multiple-output antenna according to claim 11, wherein the first pattern and the second pattern transmit signals of the same frequency band.

19. The multiple-input multiple-output antenna according to claim 18, wherein the first pattern and the second pattern have the same shape.

20. The multiple-input multiple-output antenna according to claim 11, wherein, when the first antenna and the second antenna satisfy a voltage wave standing ratio criterion of 3.0 or less in a frequency band of 2.45 GHz, insertion loss is greater than −30 dB but less than 20 dB.

21. The multiple-input multiple-output antenna according to claim 12, wherein the first pattern is formed as a spiral pattern formed in a clockwise direction from a starting point thereof, and the second pattern is formed as a spiral pattern formed in a counterclockwise direction from a starting point thereof.

22. The multiple-input multiple-output antenna according to claim 21, wherein the third pattern is formed as a spiral pattern formed in the clockwise direction from a starting point thereof.

23. The multiple-input multiple-output antenna according to claim 21, wherein an interval between portions of the spiral pattern formed as the first pattern is the same as an interval between portions of the spiral pattern formed as the second pattern.

24. The multiple-input multiple-output antenna according to claim 23, wherein an interval between portions of the spiral pattern formed as the third pattern is smaller than the interval between the portions of the spiral pattern formed as the first pattern and the interval between the portions of the spiral pattern formed as the second pattern.

25. The multiple-input multiple-output antenna according to claim 21, wherein a line width of the spiral pattern formed as the first pattern is the same as a line width of the spiral pattern formed as the second pattern.

26. The multiple-input multiple-output antenna according to claim 25, wherein a line width of the spiral pattern formed as the third pattern is the same as the line width of the spiral pattern formed as the first pattern.

27. The multiple-input multiple-output antenna according to claim 11, wherein the first antenna and the second antenna transmit signals of different frequency bands.
